(19) United States
(12) Patent Application Publication
(10) Pub. No.: US 2016/0088844 A1
(43) Pub. Date: Mar. 31, 2016

(54) NON-SELECTIVE, PRE-EMERGENCE HERBICIDE

(71) Applicant: Jessie Leanne Preston MACALPINE, Woodstock (CA)

(72) Inventor: Jessie Leanne Preston MACALPINE, Woodtock (CA)

(21) Appl. No.: 14/891,204

(22) PCT Filed: May 15, 2013
(86) PCT No.: PCT/CA2013/000470

§ 371 Date: Nov. 13, 2015

(51) Int. Cl. A01N 47/46; A01N 65/08; A01N 43/90

(52) U.S. Cl. CPC A01N 47/46; A01N 43/90; A01N 65/08

(57) ABSTRACT

The present invention relates to a pre-emergent and non-selective herbicidal composition comprising an isothiocyanate and caffeine and to methods of controlling unwanted vegetation. The isothiocyanate can be obtained from an aqueous extract of garlic mustard roots and the caffeine can be obtained from an aqueous extract of used coffee grounds. Isothiocyanate and caffeine can also be provided in substantially pure form.

### FIELD OF THE INVENTION

The present invention relates to non-selective, pre-emergence herbicide.

### BACKGROUND OF THE INVENTION

The concept of agriculture dates back to 10,000 B.C., with origins in Southern Asia (Rao, 2000). The need to feed has always been present, and learning to cultivate the land has largely contributed to the development of human society. Since its origin, agriculture has grown from single family farms to a billion dollar industry. Weed control is as old as agriculture itself, as early farmers noted undesirable plants interfere with the utilization of land and water resources (Hay, 1974). Weeds can be classified as annuals, perennials or biennials, where each group is divided between dicotyledonous and monocotyledonous plants (Jensen, 1971). Weeds have evolved survival mechanisms to ensure their persistence, such as excessive seed production, survival in an adverse environment and seed dormancy (Rao, 2000). Delayed germination as a result of seed dormancy is especially important in weed survival, as seeds are able to wait for desirable environmental conditions to return before germinating (Rao, 2000). Thus, when soil is disturbed during tillage, aeration allows weed seeds to germinate and emerge before or with crops (Rao, 2000).

In agriculture, weeds compete with desirable plants for nutrients, water and sunlight. Crop quality is significantly reduced in the presence of weeds, resulting in a decrease in market value (Parker & Fryer, 1975). Weeds harbour insects, pathogens, fungi and other microorganisms which attack desirable crop plants. In view of the foregoing, synthetic herbicides have been developed to control or kill weeds and improve crop yields in modern agriculture. Unfortunately, even with the application of these chemicals, 30% of the world's food supply is destroyed by insects, weeds, rodents and disease each year, where weeds are responsible for 45% of the observed damage (Rao, 2000). In fact, if all weed growth were eliminated, global crop yields would increase by 10-25%, an important factor to consider with the increasing population. Weeds cause bay fever and other assorted allergies, acting as a major contributor to chronic human illness (Hammerton, 1981). Many global municipalities have banned synthetic herbicide-use in consumer lawns and gardens due to documented carcinogenic effects (Morrison et al., 1992), which may result in an exacerbation of the mentioned hay fever and other allergies.

Chemical weed control began in 1890 with the production of the first spray herbicides (Timmons, 1970). In 1925, the compound sodium chlorate was introduced, paving the way for the first synthetic herbicide2-methyl-4,6-dinitrophenol (Timmons, 1970). Later, in 1947, the common herbicides 2,4-D and 2,3,5-T were produced and used to destroy forests and prevent enemy advance during the Vietnamese War (Rao, 2000). 2,4-D is largely responsible for overcoming the massive food shortages following the Second World War (Rao, 2000). After the introduction of these chemical herbicides, global crop yields increased by 19% (Rao, 2000).

Herbicides can be broadly divided between two main categories: inorganic and organic (Rao, 2000). Most of the common herbicides in modern agriculture are organic and can be further divided into one of 27 categories based on chemical mode of action (Rao, 2000). The value of an herbicide is determined based on chemical and physical properties, solubility in water, and miscibility with other herbicides. Pre-emergence control methods inhibit germination, killing weed seeds prior to sprouting (Rao, 2000). These chemicals often have a long residual effect as they exhibit low water solubility and are therefore safe as they cannot easily cross the human skin barrier (Rao, 2000). Post-emergence herbicides exhibit selective growth inhibition and have a short half-life (Rao, 2000). These chemicals remain in the soil for a short period time, quickly being neutralized by natural degradation or absorption into soil particles (Rao, 2000).

All herbicides and herbicidal compositions may be also classified into groups such as artificial or synthetic herbicides and natural herbicides which contain plant oil combinations as a subset. The larger classification, i.e., synthetic or artificial herbicides include, for example, 2,4-D or Glyphosate, which is primarily used for weed control. However, synthetic herbicides are not permitted for use in applications such as organic farming.

Glyphosate is a non-selective, post-emergence weed control method that is absorbed through leaves to inhibit essential amino acid biosynthesis (Franz et al., 1997). Its versatility, efficacy and low mammalian and environmental toxicity made it a popular herbicide over the past forty years (Rao, 2000). Originally, glyphosate's broad spectrum nature resulted in the compound having to be applied before crop planting or directly onto undesirable plants (as even a small amount of exposure could inhibit crop growth). It became a global pre-treatment in wheat crops until Monsanto introduced glyphosate-resistant crop strains (Nandula et al., 2005). This resulted in an escalated use of the herbicide and eventual weed resistance (Nandula et al., 2005). Over the past fifty years, the increase in herbicide use has resulted in resistance being observed in over 150 different species of weeds (Rao, 2000). Resistance is the result of selection of alleles which allow plants to avoid the previously fatal effects of herbicide application (Rao, 2000). Crop production is thus becoming an increasingly expensive endeavor as the global population and weed resistance increases, rendering several herbicides ineffective and reducing crop yields (Rao, 2000).

A possible alternative to synthetic herbicides is the utilization of natural plant products. Allelopathy is when a plant releases compounds into the environment that affect the growth of surrounding plant species (Rice, 1974). Allelochemicals produced by allelopathic plants are known as iosthiocyanates, which inhibit plant growth pre and post emergence, eliminating the need for multiple synthetic herbicides (Rizvi et al., 1992). These secondary metabolites are a product of plant metabolism, produced throughout the plant life cycle in the roots, leafs and seeds of various species (Rizvi et al., 1992). Allelochemicals exist in varying organic structures, ranging from terpenoids to fatty acids to alcohols (Rao, 2000). Production of these biochemicals increases in environments lacking optimal growth conditions, such as in mineral deficient soils, drought or cool temperatures (Rao, 2000). Allelochemicals produced by plants are effective by either inhibiting root and shoot length, inhibiting nutrient uptake, or attacking naturally occurring symbiotic relationships (Rao, 2000).

Garlic mustard (Alliaria petiolata) is a biennial flowering plant in the mustard family, that is native to Eurasia. This weed has been an invasive species in Canada and parts of the USA since it was first introduced in the 1860s (Nuzzo, 2002). Vaughn and Berhow (1999) found that A. petiolata is a successful invasive due to its allelopathic ability to inhibit germination of surrounding plants. A. petiolata also negatively affects the mutualism between tree roots and their mycorrhizal fungi (Stinson et. al. 2006). Due to its dominance in forests, A. petiolata has become increasingly problematic, both directly, and indirectly, to native plant species such as Acer saceharum (sugar maple) and Faxinus americana (white ash). The allelochemical that produces this inhibition of plant growth is currently uncharacterized (Pratiet. al. 2004). Similar to A. petiolata, Coffea arabica (commonly known as coffee) is allelopathic (Friedman & Waller, 1983). The alkaloid caffeine present in C. arabica has been reported to inhibit mitosis in the roots of plants and inhibit seed germination in a variety of species (Chou & Waller, 1979). It has not been investigated, however if the used coffee grounds regularly thrown out by restaurants and households could be used to inhibit weed growth.

Therefore, one object of the present invention is to provide an herbicide, natural or synthetic, suitable controlling the growth of unwanted plants.

A further object of the invention is to provide an herbicide that exhibits no toxicity towards the environment.

A further object of the invention is to provide an herbicide that can inhibit both seedling root and shoot growth of unwanted plants.

A further object of the invention is to provide an herbicide that exhibits fertilizing characteristics.

Further and other objects of the invention will be realized from the following Summary of the Invention, the Discussion of the Invention and the embodiments and Examples thereof.

### SUMMARY OF THE INVENTION

In one embodiment, the present invention provides for a natural or synthetic herbicide suitable controlling the growth of unwanted plants or vegetation. In one embodiment, the present invention is an herbicide that is a synergistic combination of isothiocyanate and caffeine.

The inventor, unexpectedly discovered that a combination of aqueous extracts obtained form garlic mustard roots and used coffee grounds resulted in a non-selective, pre-emergence, herbicidal composition that concurrently inhibit both seedling root and shoot growth of unwanted plants.

As such, in one embodiment, the present invention provides for a pre-emergent and non-selective herbicidal composition comprising an isothiocyanate and caffeine.

In one embodiment of the pre-emergent and non-selective herbicidal composition of the present invention, the isothiocyanate is provided as an aqueous solution of a source of the isothiocyanate.

In another embodiment of the pre-emergent and non-selective herbicidal composition of the present invention, the source of isothiocyanate is selected from mustard wasabi, horseradish, mustard and radish.

In another embodiment of the pre-emergent and non-selective herbicidal composition of the present invention, the caffeine is provided as an aqueous solution of a source of caffeine.

In another embodiment of the pre-emergent and non-selective herbicidal composition of the present invention, the source of the caffeine is selected from coffee beans, yerba mate, tea, cacao beans, cola nut, and guarana.

In another embodiment of the pre-emergent and non-selective herbicidal composition of the present invention, the source of the caffeine is used coffee grounds.

In another embodiment of the pre-emergent and non-selective herbicidal composition of the present invention, the herbicide comprises a combination of an aqueous solution of a source of the isothiocyanate and an aqueous solution of a source of the caffeine.

In another embodiment of the pre-emergent and non-selective herbicidal composition of the present invention, the isothiocyanate solution is obtained from 500 g of the source of isothiocyanate per liter of water, and wherein the caffeine solution is obtained form 500 g of the source of caffeine per liter of water.

In another embodiment of the pre-emergent and non-selective herbicidal composition of the present invention, the volume ratio of the isothiocyanate solution to the caffeine solution is between 1:99 to 99:1.

In another embodiment of the pre-emergent and non-selective herbicidal composition of the present invention, the volume ratio of aqueous solution of the source of the isothiocyanate to aqueous solution of the source of caffeine is selected from the group consisting of: 20:80, 40:60, 50:50, 60:40 and 80/20.

In another embodiment of the pre-emergent and non-selective herbicidal composition of the present invention, the isothiocyanate and the caffeine are provided in substantially pure form dissolved in a suitable carrier.

In one embodiment, the present invention provides for a method of pre-emergently and non-selectively controlling unwanted vegetation. The method, in one embodiment, includes applying to an environment where unwanted vegetation is present or expected to be present a herbicidally effective amount of isothiocyanante and caffeine in combination.

In one embodiment of the method of pre-emergently and non-selectively controlling unwanted vegetation of the present invention, the isothiocyanate is provided as an aqueous solution of a source of the isothiocyanate.

In another embodiment of the method of pre-emergently and non-selectively controlling unwanted vegetation of the present invention, the source of isothiocyanate is selected from wasabi, horseradish, mustard, radish, Brussels sprouts, watercress, nasturtiums, and capers.

In another embodiment of the method of pre-emergently and non-selectively controlling unwanted vegetation of the present invention, the caffeine is provided as an aqueous solution of a source of the caffeine.

In another embodiment of the method of pre-emergently and non-selectively controlling unwanted vegetation of the present invention, the source of the caffeine is selected from coffee beans, yerba mate, tea, and guarana. In another embodiment of the method of pre-emergently and non-selectively controlling unwanted vegetation of the present invention, the source of the caffeine is used coffee grounds.

In another embodiment of the method of pre-emergently and non-selectively controlling unwanted vegetation of the present invention, the combination comprises an aqueous solution of a source of the isothiocyanate and an aqueous solution of a source of the caffeine.

In another embodiment of the method of pre-emergently and non-selectively controlling unwanted vegetation of the present invention, the isothiocyanate solution is obtained from 500 g of the source of isothiocanate per liter of water, and wherein the caffeine solution is obtained form 500 g of the source of caffeine per liter of water.

In another embodiment of the method of pre-emergently and non-selectively controlling unwanted vegetation of the present invention, the ratio of aqueous solution of the source of the isothiocyanate to aqueous solution of the source of caffeine is between 1:99 to 99:1.

In another embodiment of the method of pre-emergently and non-selectively controlling unwanted vegetation of the present invention, the volume ratio of aqueous solution of the source of the isothiocyanate to aqueous solution of the source of caffeine is selected from the group consisting of: 20:80, 40:60, 50:50, 60:40 and 80:20.

In another embodiment of the method of pre-emergently and non-selectively controlling unwanted vegetation of the present invention, the volume ratio of aqueous solution of the source of the isothiocyanate to aqueous extract of the source of caffeine is 50:50 and in that the dosage rate of the combination is 80 to 120 liters of herbicide per hectare.

In one embodiment, the present invention provides for a method of concurrently inhibiting seedling root and shoot growth of vegetation, the method comprising exposing the seeds of the unwanted plants to a herbicidally effective amount of isothiocyanante and caffeine in combination.

In another embodiment, the present invention provides for a method of manufacturing a pre-emergent, non-selective herbicide comprising combining an effective amount of isothiocyanate with an effective amount of caffeine.

In one embodiment of the method of manufacturing a pre-emergent, non-selective herbicide of the present invention, the isothiocyanate is provided as an isothiocyanate aqueous solution obtained from a source of the isothiocyanate, and wherein the caffeine is provided as a caffeine aqueous solution obtained from a source of caffeine.

In another embodiment of the method of manufacturing a pre-emergent, non-selective herbicide of the present invention, the isothiocyanate solution is obtained from 500 g of the source of isothiocyanate per liter of water, and wherein the caffeine solution is obtained form 500 g of the source of caffeine per liter of water.

In another embodiment of the method of manufacturing a pre-emergent, non-selective herbicide of the present invention, the isothiocyanate and the caffeine are provided in substantially pure form.

### BRIEF DESCRIPTION OF THE DRAWINGS

The following figures illustrate various aspects and preferred and alternative embodiments of the invention.

FIG. 1 is a graph illustrating the germination over time of R. sativus in the presence of different concentrations of aqueous extracts of garlic mustard root.

FIG. 2 is a graph illustrating average plant and root length of R. sativus when aqueous garlic mustard root extract is applied after planting (post-emergence).

FIG. 3 is a graph illustrating germination over time of Taraxacum officinale (T. officinale) seeds in the presence of an aqueous extract of garlic mustard root.

FIG. 4 is a graph illustrating R. sativus germination in the presence of different concentrations of an aqueous extract of C. arabica grounds. “a”—statistically different from “b”; and “b”—statistically different form “a”.

FIG. 5 is a graph illustrating R. sativus germination in the presence of 50/50 ratio of 500 g/L aqueous extract of A. petiolata and 500 g/L aqueous extract of C. arabica grounds. “a”—statistically different from all other groups; “b”—statistically different from “a”, “c” and “d”; “c”—statistically different from “a”, “b” and “d”; “d”—statistically different from all other groups; and “bc”—statistically different from “a” and “d”.

FIG. 6 is a graph illustrating the average R. sativus seedling length in the presence of different ratios of herbicidal compositions of the present invention. “a₁”—statistically different from “b₁” and “c₁”; “ab₁”—statistically different from “c₁”; “b₁”—statistically different from “a₁” and “c₁”; “ab₁”—statistically different from “c₁”. “a₂”—statistically different from bc₂, b₂, “c₂” and “d₂”; “bc₂”—statistically different from “a₂” and “d₂”; “b₂”: statistically different form “a₂”, “c₂” and “d₂”; “c₂”—statistically different from “a₂”, “b₂” and “d₂”; and “d₂”—statistically different from “a₂”, “bc₂”, “b₂”, and “c₂”.

FIG. 7 is a graph illustrating percent of germination of R. sativus with various applications (before, with and/or after seeding) of the herbicidal composition of the present invention. “ab”—statistically different from “c” and “d”; “a”—statistically different from “b”, “c” and “d”; “b”—statistically different from “a”, “c” and “d”; “c”—statistically different from “a”, “b”, “ab” and “d”; and “d”—statistically different from “a”, “b”, “ab” and “c”.

FIG. 8 is a graph illustrating germination of A. thaliana in the presence of the herbicidal composition of the present invention, a filtered herbicidal composition of the present invention and control.

FIG. 9 are photographs illustrating germination of A. thaliana in the presence of control (A) Control, (B) the herbicidal composition of the present invention and (C) a herbicidal composition of the present invention filtered through a 20 &m natural cellulose filter.

FIG. 10 is a graph illustrating the average total plant and root length of R. sativus in the presence of different concentrations of aqueous extracts of garlic mustard root and control.

FIG. 11 illustrates a comparison in the proportion of germination of R. Sativus germinated when an aqueous extract of garlic mustard root is applied one week after planting the R. sativus seeds and a control. applied one week after planting.

FIG. 12 is a graph illustrating the total plant length and root length of T. officinale in the presence of a garlic root extract and a control.

### DESCRIPTION OF THE INVENTION

### Definitions

Unless defined otherwise, all technical and scientific terms used herein have the same meaning as commonly understood by one of ordinary skill in the art to which this invention belongs. Also, unless indicated otherwise, except within the claims, the use of “or” includes “and” and vice versa. Non-limiting terms are not to be construed as limiting unless expressly stated or the context clearly indicates otherwise (for example “including”, “having” and “comprising” typically indicate “including without limitation”). Singular forms including in the claims such as “a”, “an” and “the” include the plural reference unless expressly stated otherwise. In order to aid in the understanding and preparation of the within invention, the following illustrative, non-limiting, examples are provided.

“Effective amount” refers to an amount of the composition that is capable of producing a desirable result in a treated substrate or turf. The methods of the present invention may be performed alone or in combination with other known herbicidal compositions.

In the case of combinations of herbicides, the term “synergism” is used generally to indicate a response in excess of that expected from the sum of the effects of various chemicals when used separately under the same conditions.

“Treating” or “controlling” refers to administration or application of a herbicidal composition to substrate or turf, including a field or a pot, that is suffering or is at risk of developing weed infestation, with the purpose to inhibit, alleviate, relieve, remedy, prevent or ameliorate growth of unwanted weeds.

Herbicidal Compositions The present invention provides for an herbicide suitable for controlling the growth of unwanted plants or vegetation, including weeds.

There has always been a long sought need for manufacture of natural “organic” herbicides i.e., herbicides that are completely based on the natural constituents and more importantly, organic herbicides that approach the effectiveness of synthetic herbicides but that are environmentally safe.

A non-selective, pre-emergence herbicide having natural ingredients has been developed that may concurrently inhibit both seedling root and shoot growth of unwanted plants. This stability translates into an herbicide, which after application, remains longer on the treated environment and thus remains an effective herbicide for a longer duration.

The present invention, in one embodiment, relates to a non-selective, pre-emergent herbicidal composition comprising an isothiocyanate and caffeine.

The inventor, unexpectedly, discovered that a combination of extracts obtained form garlic mustard roots (a source of isothiocyanate) and used coffee grounds (a source of caffeine) resulted in a non-selective, pre-emergence, herbicidal composition that concurrently inhibit both seedling root and shoot growth of unwanted plants. Non-limiting examples of unwanted plants may include annual grasses, annual broadleaves, perennial grasses and perennial broadleaves. Non-limiting examples of weeds are ryegrass, mixed crabgrass, mixed foxtails, mixed bluegrass, mixed fescues, Canada thistle, chickweed, dandelion, yellow nutsedge, common lambsquarter, lantana and johnsongrass.

The herbicidal composition of the present invention, in one embodiment, may be obtained by combining an extract of a source of isothiocyanate with an extract of a source of caffeine, which together act as a natural herbicide that is more effective than each of its constitutive parts. It is known in the art that garlic mustard (a source of isothiocyanate) and caffeine, separately have been used as herbicides. However, either garlic mustard roots or coffee grounds separately are of a limited duration and limited effectiveness. Herein, it has been discovered that combining a garlic mustard solution with a solution of coffee grounds, which may be provided as used coffee grounds, produces a synergistic effect with greater and more efficient inhibitory affect than by using the two ingredients separately (see FIG. 9).

In one embodiment, the herbicidal composition of the present invention may include a solution obtained from the roots of A. petiolata (garlic mustard) and a solution obtained of coffee grounds.

Aqueous extracts are substantially simpler and because of the use of water-based solutions, no toxic solvents are needed. However, because the active ingredient isothiocyanate is soluble in lipid it may be necessary to retain solid particles that include isothiocyanate. The aqueous solution rich in isothiocyanate may be obtained by, for example, macerating the roots of the plant and soaking the crushed mixture in an aqueous fluid like water for a period of time, for example 24 hours. The large solid particles may then be filtered out using a filter, such as cheesecloth, but which may allow for substantially finer/smaller particles and the active ingredient isothiocyanate to be retained in the remaining solution. The remaining solution may then be used as the isothiocyanate-based component of the herbicidal composition of the present invention.

The caffeine solution may be prepared, for example, by collecting coffee grounds (which may be used coffee grounds) and soaking them in an aqueous fluid like water for a period of time, for example 24 hours. The resulting solution may be filtered to remove the solid grounds so as to obtain a solution that includes caffeine.

The two solutions may then be combined in different proportions to produce a herbicide of the present invention.

The two solutions may be further diluted prior to combining them. For example, each extract may be diluted into from about 0% to about 100% solutions using water or a suitable solvent.

To form the herbicidal composition of the present invention, the two extracts may be combined in different proportions from 1/99 to 99/1 ratios (isothiocyanate/caffeine), including 50/50, 60/40, 40/60, 80/20 and 20/80.

The herbicidal composition of the present invention may also be prepared by combining the substantially purified active ingredients isothiocyanate and caffeine. Isothiocyanate may, for example, be obtained from as allyl isothiocyanate from Fluka (Deisenhofen, Germany). Caffeine in pure form may be obtained from a number of sources (see for example purebulk.com).

Isothiocyanate may be purified with the use of organic solvent extractions, which may include drying the sample, grounding the dried sample prior to solvent extraction, and solvent for lipid extraction. The solvent may be selected from hexane, methylene chloride, and ethyl acetate. Methods for extracting isothiocyanate from a plant are known in the art (see for example Food Sci. Biotechnology, 19(2):405-410 (2010); US Pat. Appl. No. 20110245526, which are hereby incorporated by reference).

The caffeine may be purified using a solvent extraction, for example using chloroform. The caffeine in the caffeine source may dissolve into the chloroform and the rest of the source may be discarded. The chloroform extraction may be repeated a number of times so that the amount of caffeine left in the discarded material may be minimized. This may be followed by washings with sodium hydroxide and water. As such, in another embodiment, the present invention provides for an herbicidal composition comprising a compound having an isothiocyanate group —N═C—S, such as allyl isothiocyanate and benzyl isothiocyanate, in combination with caffeine.

Sources of isothiocyanate may include garlic mustard roots, wasabi, horseradish, mustard, radish, Brussels sprouts, watercress, nasturtiums, capers and so forth. Sources of caffeine may include coffee seeds, tea, yerba mate, cola nuts, guarana berries and so forth. As such, in yet another embodiment, the herbicidal composition of the present invention may include combinations of aqueous extracts obtained from one or more of the sources of isothiocynate with aqueous extracts obtained from one or more sources of caffeine.

Additional allelochemicals, which may be provided as extracts, may be added to the herbicidal compositions of the present invention.

It should be understood that the present invention includes any source of the active ingredients: naturally obtained or synthetic.

It is also well-known that organic acids may improve the effectiveness of organic herbicides. Accordingly, the herbicidal compositions of the present invention may also include organic acids such as acetic acid and/or citric acid.

Methods of Controlling Unwanted Vegetation

The herbicidal compositions of the present invention may be used as pre-emergence herbicides. There are two types of herbicide applications, pre-emergence herbicides, which prevent weed seeds from germinating or emerging, and post-emergence herbicides, which kill emerged and actively growing plants.

Pre-emergence turf herbicides are generally more effective, but must be applied early in the season before annual weed seeds germinate. In order to provide season-long control pre-emergent herbicides may need to be reapplied six to eight weeks after the initial application.

As such, in another embodiment, the present invention relates to a method of controlling unwanted vegetation. In one embodiment, the method may be a method of pre-emergently combating unwanted vegetation. In another embodiment the method may be a method of non-selectively controlling unwanted vegetation. The methods, in one embodiment, may include applying to an environment, such as a turf or locus where unwanted vegetation is present or expected to be present, a herbicidally effective amount of a composition comprising an isothiocyanate and caffeine. The method may further include reapplying the herbicide after the first application.

For spraying purposes, both ingredients may be generally dispersed or suspended in a sufficient amount of a suitable solution, including water, to give complete and uniform coverage of the target environment weeds and the spray mix may be advantageously applied by conventional herbicide ground spraying equipment. Although the synergistic effects of the components of the herbicide of the present invention may be observed when the active compounds are applied jointly, they may also frequently be observed when the active compounds are applied at different times (splitting), that is, each component may be applied substantially simultaneously in separate formulations with the effect of a combined application.

Because the herbicidal compositions of the present invention may include natural components, the herbicidal composition may also be used as a fertilizer for already germinated plants.

Advantages

The herbicide of the present invention is a non-selective, pre-emergence herbicide which, in one embodiment, combines a solution of garlic mustard roots with a solution of used coffee grounds. Combined, these two components are able to substantially inhibit seed germination (up to 100% inhibition has been observed) in a variety of plant species, both in the laboratory and field environment. Based off of the principles of allelopathy, the herbicide of the present invention is able to concurrently inhibit both seedling root and shoot growth. When using 500 g of garlic mustard root per liter of water used in the extraction, and 500 g of coffee grounds per liter of water for extraction, no measurement of plant length, seedling root and shoot growth was possible because the herbicide inhibited almost 100% of the germination. However, with decreasing concentration of the source materials it was possible to make measurements and confirm that they were significantly smaller. However, when applied to previously germinated plants, the composition of the present invention exhibits no inhibitory effects and acts as a fertilizer. An application of 80-120 liters, preferably 100 liters, of the herbicide per hectare may be used to produce the observed germination inhibition, which is approximately a third less than the standard for herbicide use in modern agriculture. Composed of edible matter, the herbicide of the present invention has not been found to exhibit any toxicity towards the environment. The herbicide of the present invention may be applied in consumer lawns and gardens, as well as in cash crops, where seedlings are sprouted in a greenhouse before being transferred to the field. In these instances, the herbicide of the present invention may inhibit germination of weed seeds while fertilizing crops sprouts. The herbicide of the present invention is thus an environmentally and economically friendly alternative to modern weed control techniques.

Embodiments of the invention are described in the following specific example which is not to be construed as limiting.

### EXAMPLES

For the following examples, aqueous extracts (also referred to in this document as solutions) of Alliaria petiolata (garlic mustard) roots and Coffea Arabica grounds were prepared according to the following procedures. Solutions of Alliaria petiolata (garlic mustard) roots were prepared by macerating the roots of the plant and soaking the crushed mixture in water (concentration of 500 g/liter of water) for 24 hours. The mixture was then filtered with cheesecloth to remove substantially larger solid particles. The remaining solution (still has some sediment/particles and include the active ingredient isothiocyanate) is then used alone or as the garlic mustard component of the herbicidal composition used in the examples below. Solutions of used Coffea arabica grounds were prepared by collecting used coffee grounds and soaking them in water (500 g/liter of water) for 24 hours before filtering out the grounds. The remaining solution may be used alone or added in to the garlic mustard extract to produce the herbicide.

### Example 1

### Examining Inhibitory Properties of Garlic Mustard

Different concentrations of the A. petiolata solutions were obtained by diluting the extract with distilled water to obtain 100% (i.e. no water added, 500 g/L), 50%, 25%, 12.5%, 6.25%, 3.125% and 0% (just water control) solutions. Seven six-well culture plates were assigned to each of these solutions and then ten, surface sterilized R. sativus seeds (which were chosen due to their fast germination rate), 14 g of sterilized potting soil, 2 mL of extract (or 2 mL of water control) and 2 mL of dechlorinated tap water were put into each well. The seeds were then left to germinate for six days and the number of seeds germinated, and seedling total and root length were recorded. An additional experiment was set up as above where the 500 g/L extract was added after seeds had been left to germinate for one week.

As illustrated in FIG. 1, the 100% solution of 500 g/L garlic mustard extracts significantly reduced germination. The 500 g/L (100%) extract inhibited germination significantly more effectively than the 100 g/L extract (df=2, chisq=104.93, P=<0.001).

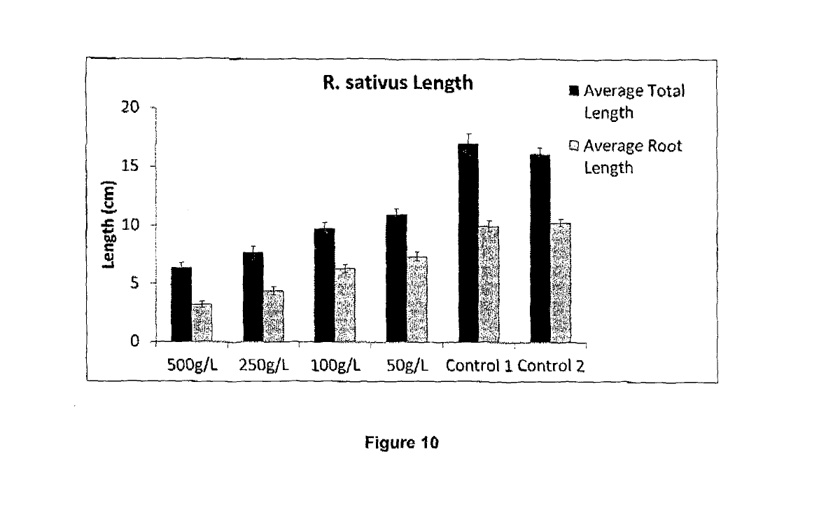

As illustrated in FIG. 10, the 100% solution significantly reduced total seedling and root length (df=2, tdf=311, F=29.846, P=<0.001).

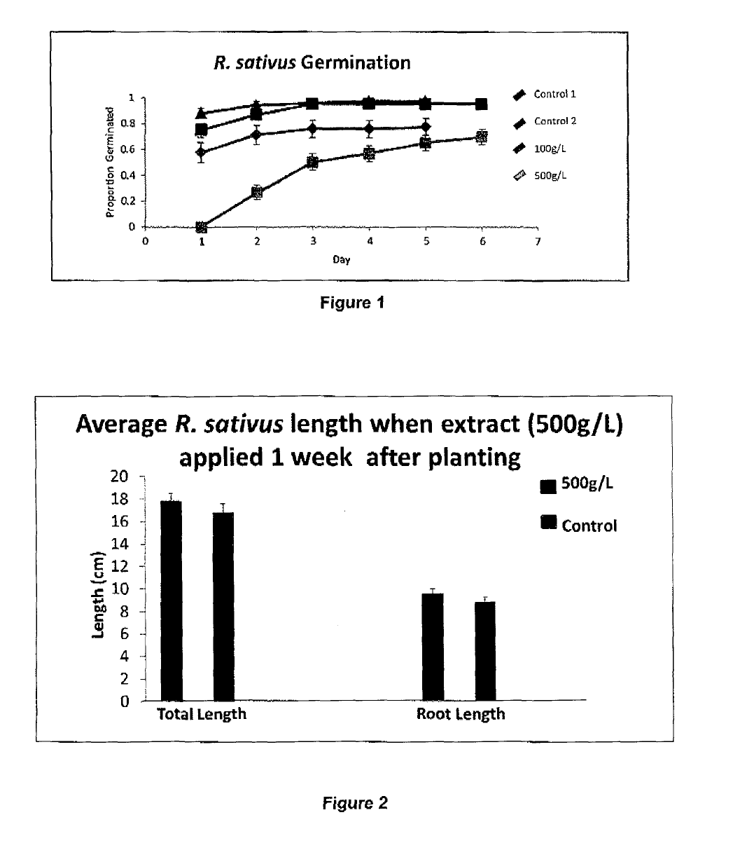

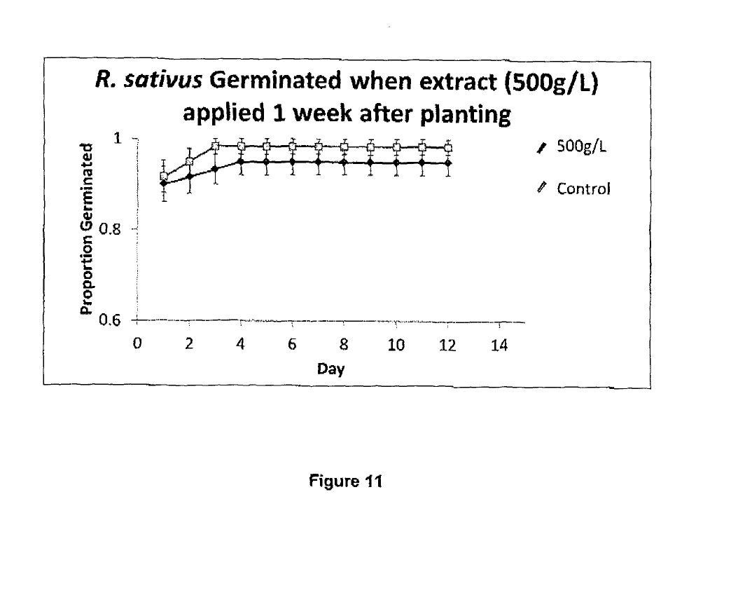

As shown in FIG. 2, it was determined that the 500 g/L extract of garlic mustard roots does not affect the growth of previously germinated R. sativus seeds when applied one week after planting. No difference was found in total length (df=1, tdf=112, F=0.93, P=0.337) and root length (df=1, tdf=112, F=1.65, P=0.202) of radish (R. sativus) seedlings when the aqueous extract is applied 1 week after planting. As shown in FIG. 11, when the garlic mustard root aqueous extract is applied one week after planting, it does not affect germination.

### Example 2

### Examining Garlic Mustard Efficacy in a Grass-Dandelion Model

A 500 g/L (100%) extract of garlic mustard roots was used to inhibit germination in the grass-dandelion model. Twelve plots (diameter of 24 cm) of a mixture of perennial grasses (Elite Estate, Art Haight Lawn and Landscaping Incorporated) were grown for two weeks. The twelve plots were then split into four experimental groups. Experimental group one contained 25 T. officinale (dandelion) seeds, which were applied to the soil surface. Experimental group two was applied with 100 mL of the extract so that it could be determined whether the allelochemicals had any effect on the growth of grass which had previously germinated. Experimental group three was applied with 100 mL of extract and 25 T. officinale seeds to determine if the extract was able to inhibit germination when sprayed onto weed seeds within standing grass. Experimental group four acted as a control and contained only the mixture of perennial grasses. Observations were then recorded for two weeks to determine if the extract effectively inhibited germination.

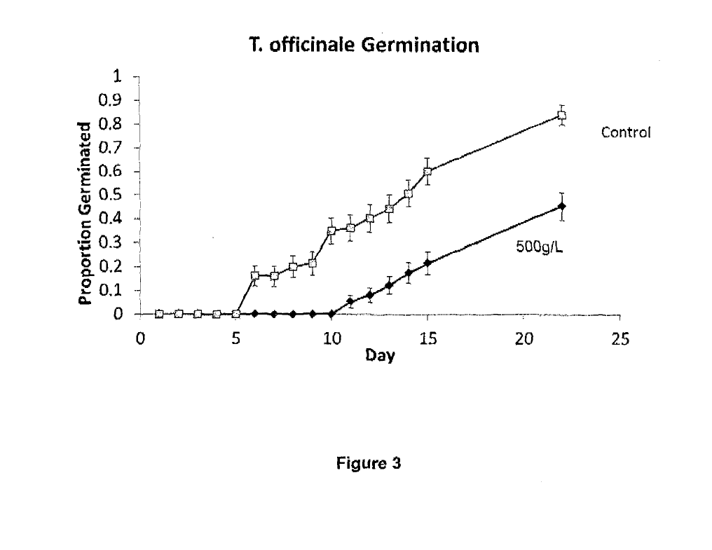

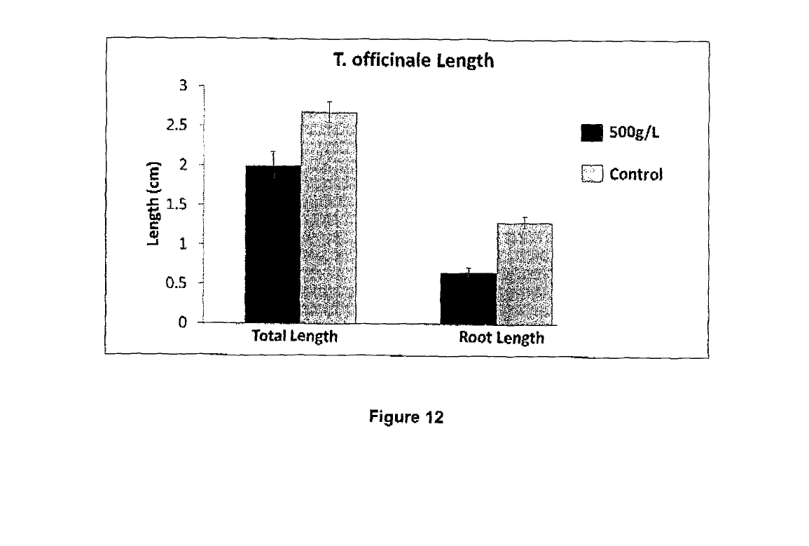

FIG. 3 shows that the 500 g/L of garlic mustard root aqueous extract was able to reduce germination (df=1, chisq=19.96, P=<0.001)). The garlic mustard root aqueous extract was able to reduce total (df=1, tdf=97, F=4.147, P=<0.001) and root length (df=1, tdf=97, F=36.323, P=<0.001) of T. officinale seeds (see FIG. 12).

### Example 3

### Examining Inhibitory Properties of Used Coffee Grounds

Used Tim Horton's® coffee grounds were used to prepare 500 g/L, 100 g/L, 50 g/L and 10 g/L aqueous extracts of C. arabica. Six six-well culture plates were then assigned to each type of coffee ground and six wells were assigned to each extract concentration. Each well contained 25 g sterilized soil, ten sterilized R. sativus seeds, 2 mL distilled water and 2 mL extract. The seeds were left to germinate for five days at 23° C. were they were exposed to 12 hours of sunlight daily.

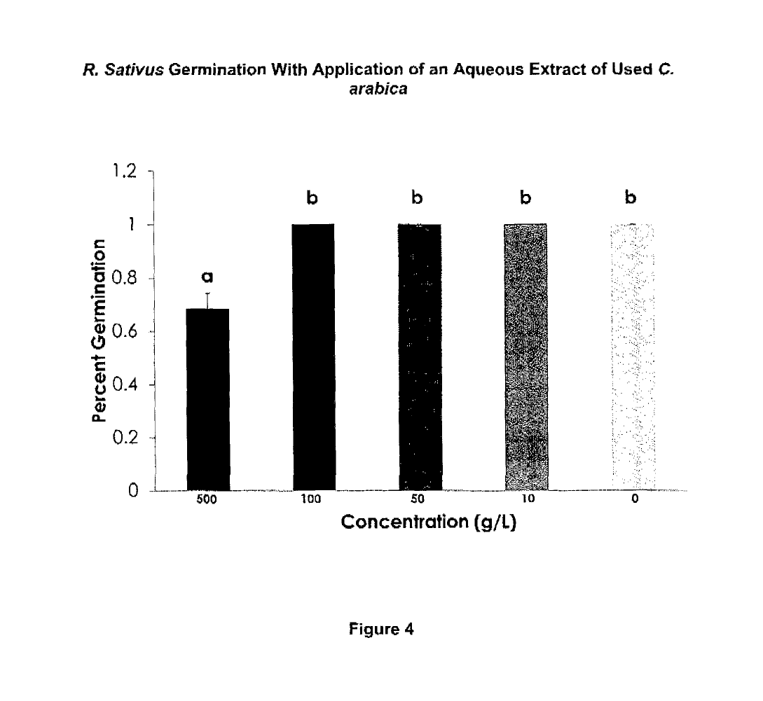

As shown in FIG. 4, it was found that a 500 g/L aqueous extract of used C. Arabica grounds significantly inhibited R. sativus germination.

### Example 4

### Combining Allelopathic Agents to Produce Synergistic Inhibitory Effect

A 500 g/L aqueous solution of macerated A. petiolata roots was combined with a 500 g/L aqueous solution of used coffee grounds to prepare (v/v) 50/50, 60/40, 40/60, 80/20 and 20/80 ratio solutions of allelopaths. Five six-well culture plates were then divided so that six wells were assigned to each ratio of extract. Each well included ten sterilized R. sativus seeds, 25 g sterilized soil, 2 mL distilled water and 2 mL of extract. The seeds were then left to germinate for five days under the same conditions as employed in Example 3.

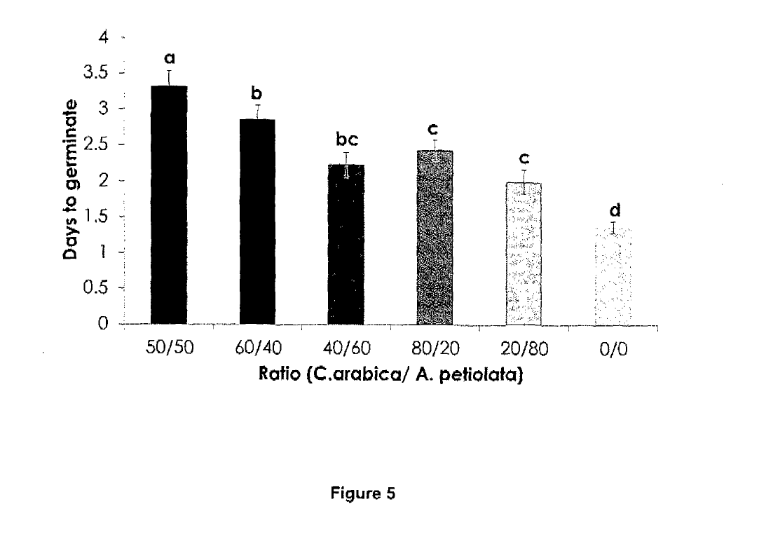

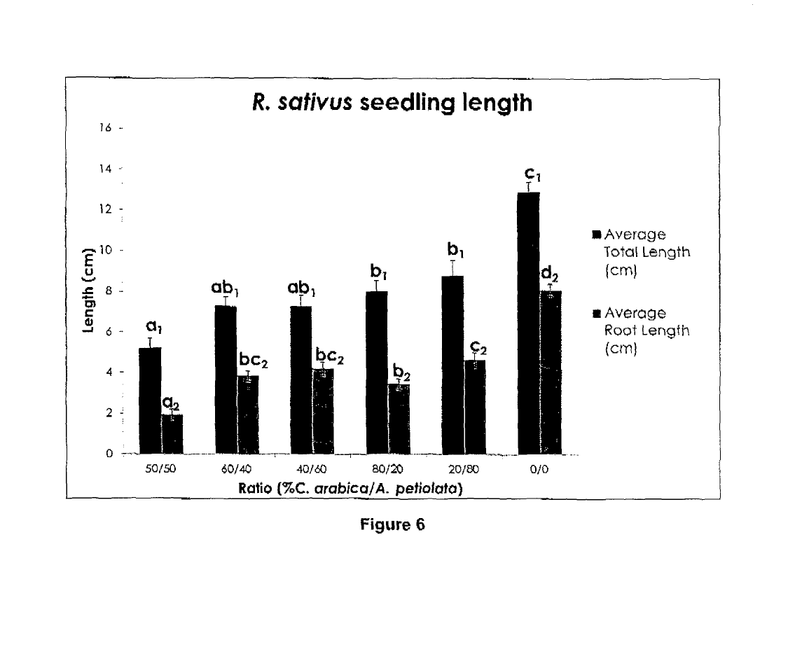

In combination, extracts of C. arabica and A. petiolata were able to significantly reduce germination (FIG. 5) as well as seedling growth (FIG. 6). As shown in FIGS. 5 and 6, more effective inhibition of germination was obtained when extracts are combined in a 50/50 ratio of 500 g/L used C. arabica grounds and 500 g/L of A. petiolata.

FIG. 5, 50/50 ratio of 500 g/L used C. Arabica grounds and 500 g/L A. petiolata was able to inhibit germination significantly more effectively than other ratios (Log Rank=90.144, d.f.=5, P=<0.001).

FIG. 6 ratio of 50/50 C. Arabica and A. petiolata was able to significantly inhibit total seedling length compared to the control (F=21.766, P=<0.001) and root length compared to all other groups (F=50.174, P=<0.001).

### Example 5

### Assessing the Method of Application for Optimum Germination Inhibition

Seven six-well culture plates were divided into seven experimental groups. The herbicide solution used was a 50/50 ratio of a 500 g/L aqueous extract of A. petiolata and a 500 g/L aqueous extract of C. arabica. The first group received the herbicide prior to the application of seeds, the second had the herbicide applied at the same time as seeding, the third had the herbicide applied twice (before and with seeding), the fourth group received two applications of herbicide (with and post seeding), the fifth group had the herbicide applied three times (before, with and post seeding), the sixth group had the herbicide applied after germination occurred and the final group acted as the control (water). Each well contained 25 g sterilized soil, 2 mL water, 10 sterilized R. sativus seeds and 2 mL extract per application. The seeds were then left to germinate for five days under the same conditions as employed in Example 3.

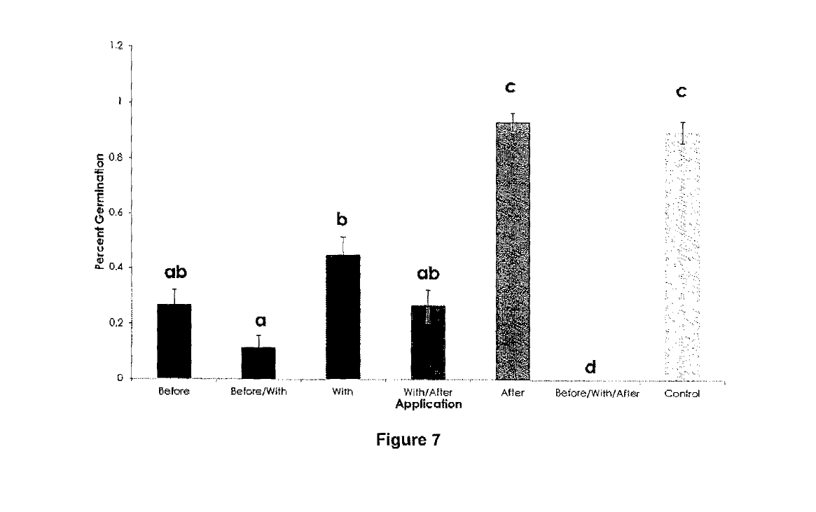

As illustrated in FIG. 7, when the herbicide was applied three times (before, with and after seeding) it was able to significantly reduce germination compared to all other methods of application (Log Rank=275.907, d.f.=6, P==0.001).

Similar experiment testing the application of the herbicide at different times as described in this Example 5, was carried out in a grass—R. sativus model similar to that described in Example 2 for grass-dandelion model. The results were the same as those observed in FIG. 7, i.e. optimal inhibition was obtained when the herbicide was applied before, with and after seeding (not shown). From this experiment it was calculated that 100 liters of herbicide per hectare of environment can be used to control growth of unwanted vegetation.

### Example 6

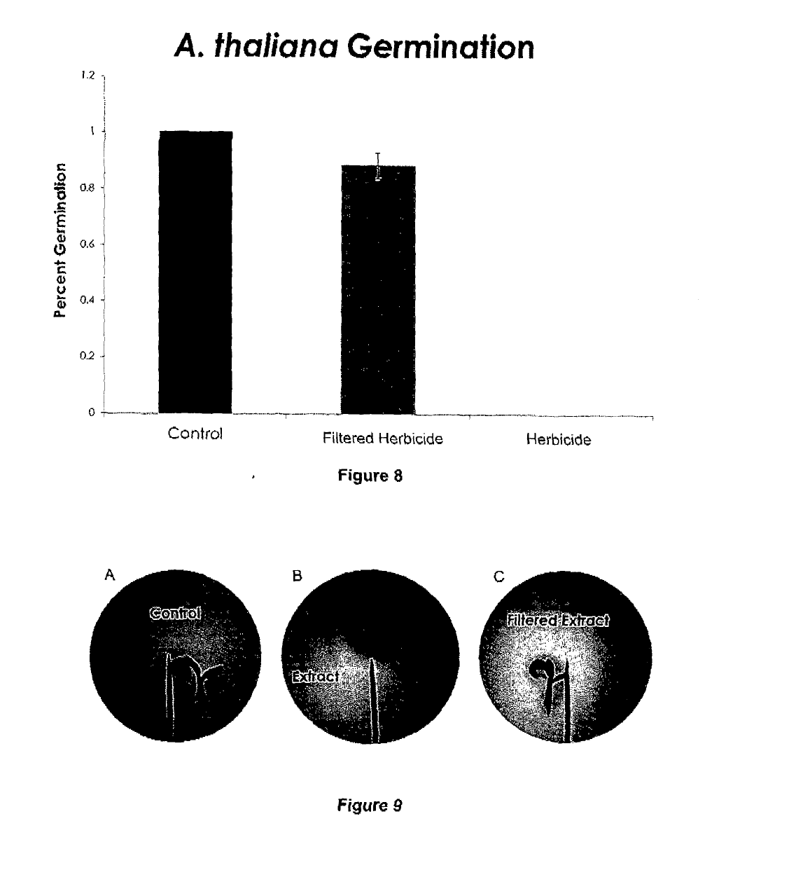

Seeds of A. thaliana were exposed to control, combination herbicide of the present invention and filtered herbicide. As shown in FIG. 8, filtration of the combination herbicide through a 20 μm cellulose filter removed the active ingredients of garlic mustard (allyl and benzyl isothiocyanate).

FIG. 9A illustrates normal germination of A. thaliana. As shown in FIG. 9 B, the remaining caffeine in the filtered extract was responsible for the reduction in root growth, however 100% germination inhibition was only observed with application of the crude form of the combination of the two extracts (FIG. 9 C).

### CONCLUSIONS

The garlic mustard solution inhibited weed germination without negatively affecting the growth of previously germinated crop seedlings. An aqueous solution of 500 g/L of garlic mustard inhibits just over 20% of germination, thereby requiring 1618 L of extract per hectare of land in order to be effective. A 500 g/L aqueous solution obtained from used coffee grounds was also able to significantly inhibit approximately 30% of germination. When combined in a 50/50 ratio the coffee solution with the garlic mustard solution, only 100 L was needed per hectare of land to inhibit 100% of germination in a variety of seeds. Evidently the combination of multiple allelochemicals produces a significantly greater inhibitory affect than the individual treatments.

The above disclosure generally describes the present invention. Changes in form and substitution of equivalents are contemplated as circumstances may suggest or render expedient. Although specific terms have been employed herein, such terms are intended in a descriptive sense and not for purposes of limitation.

### REFERENCES

Bialy, Z., Oleszek, W., Lewis, J., & Fenwick, G. R. (1990). Allelopathic potential of glucosinolates (mustard oil glycosides) and their degradation products against wheat. Plant and Soil, 129, 277-281.
Chang, F. Y. &Vanden Born, W. H. (1971). Dicamba uptake, translocation, metabolism and selectivity. Weed Science, 19, 113-117.
Chou, C.-H., and Waller, G. R. 1979. Possible allelopathic constituents of Coffea arabica. J. Chem. Ecol. 6: 643-654.
Franz, J. E., Mao, M. K., &Sikorski, J. A. (1997). Glyphosate: a unique global herbicide. American Chemical Society.
Friedman, J., and Waller, G. R. 1983. Caffeine hazards and their prevention in germinating seeds of coffee (Coffea arabica). J. Chem. Ecol. 9: 1099:1106.
Hammerton, J. L. (1981). Weed problems and weed control in the Commonwealth Caribbean. Tropical Pest Management, 27, 379-387.
Hay, J. R. (1974). Grains to the grower from weed science. Weed Science, 22, 439-442.
Jensen, L. L. (1971). Morphology and photoperiodic responses of yellow netsedge. Weed, Science, 19, 210-219.
Lin, C. M., Preston, J. F., & Wei, C. I. (2000). Antibacterial mechanism of allylisothiocyanate. Journal of Food Protection, 63, 727-734.
Morrison, H. I., Wilkins, K., Semenciw, R., Mao, Y., &Wigle, D. (1992). Herbicides and cancer. Journal of the National Cancer Institute, 84, 1866-1874.
Nandula, V. K., Reddy, K. N., Duke, S. O., & Poston, D. H. (2005). Glyphosate-resistant weeds: Current status and future outlook. Outlooks on Pest Management, 183-187.
Nuzzo, V. 2002. Element Stewardship Abstract for Alliariapetiolata (Alliaria officinalis) Garlic Mustard. The Nature Conservancy Arlington, Va.
Parker, C. & Fryer, J. D. (1975). Weed control problems causing major reductions in world food supplies. FAO Plant Protection Bulletin, 23, 83-95.
Prati, D. and Bossdorf, O. 2004. Allelopathic inhibition of germination by Alliaria petiolata (Brassicaceae). Am. J. Bot 91:285-288.
Renwick, J. A. A., Zhang, W., Haribal, M., Attygalle, A. B., & Lopez, K. D. (2001). Dual chemical barriers protect a plant against different larval stages of an insect. Journal of Chemical Ecology, 27, 1575-1583.
Rice, E. L. 1974. Allelopathy. Academic, New York.
Timmons, F. L. (1970). A history of weed control in the United States and Canada. Weed Science, 294-307.
Vaughn, S. F. and Berhow, M. A. 1999. Allelochemicals isolated from tissues of the invasive weed garlic mustard (Alliaria petiolata). J. Chem. Ecol. 25:2495-2504.

1. A pre-emergent and non-selective herbicidal composition comprising an isothiocyanate and caffeine.

2. The pre-emergent and non-selective herbicidal composition of claim 1, wherein the isothiocyanate is provided within an aqueous extract solution of a source of the isothiocyanate and the caffeine is provided within an aqueous extract solution of a source of caffeine.

3. The pre-emergent and non-selective herbicidal composition of claim 2, wherein the source of isothiocyanate is selected from wasabi, horseradish, mustard, radish, Brussels sprouts, watercress, nasturtiums and capers.

4. (canceled)

5. The pre-emergent and non-selective herbicidal composition of claim 2, wherein the source of the caffeine is selected from coffee beans, yerba mate, tea, cacao beans, cola nut, and guarana.

6. The pre-emergent and non-selective herbicidal composition of claim 2, wherein the source of the caffeine is used coffee grounds.

7. (canceled)

8. (canceled)

9. The pre-emergent and non-selective herbicidal composition of claim 2, wherein the volume ratio of the isothiocyanate extract solution in the herbicidal composition to the caffeine extract solution in the herbicidal composition is between 1:99 to 99:1.

10. The pre-emergent and non-selective herbicidal composition of claim 2, wherein the volume ratio of the aqueous extract solution of the source of the isothiocyanate in the herbicidal composition to the aqueous extract solution of the source of caffeine in the herbicidal composition is selected from the group consisting of: 20:80, 40:60, 50:50, 60:40 and 80:20.

11. A method of pre-emergently and non-selectively controlling unwanted vegetation comprising applying to an environment where unwanted vegetation is present or expected to be present a herbicidally effective amount of a herbicidal composition comprising isothiocyanante and caffeine in combination.

12. The method of pre-emergently and non-selectively controlling unwanted vegetation of claim 11, wherein the isothiocyanate in the herbicidal composition is provided within an aqueous extract solution of a source of the isothiocyanate and the caffeine in the herbicidal composition is provided within an aqueous extract solution of a source of the caffeine.

13. The method of pre-emergently and non-selectively controlling unwanted vegetation of claim 12, wherein the source of isothiocyanate is selected from wasabi, horseradish, mustard, radish, Brussels sprouts, watercress, nasturtiums, and capers.

14. (canceled)

15. The method of pre-emergently and non-selectively controlling unwanted vegetation of claim 12, wherein the source of the caffeine is selected from coffee beans, yerba mate, tea, cacao beans, cola nut and guarana.

16. The method of pre-emergently and non-selectively controlling unwanted vegetation of claim 12, wherein the source of the caffeine is used coffee grounds.

17. (canceled)

18. (canceled)

19. The method of pre-emergently and non-selectively controlling unwanted vegetation of claim 12, wherein the ratio of aqueous extract solution of the source of the isothiocyanate to aqueous extract solution of the source of caffeine in the herbicidal composition is between 1:99 to 99:1.

20. The method of pre-emergently and non-selectively controlling unwanted vegetation of claim 12, wherein the volume ratio of aqueous extract solution of the source of the isothiocyanate to aqueous extract solution of the source of caffeine in the herbicidal composition is selected from the group consisting of: 20:80, 40:60, 50:50, 60:40 and 80:20.

21. The method of pre-emergently and non-selectively controlling unwanted vegetation of claim 12, wherein the volume ratio of aqueous extract solution of the source of the isothiocyanate to aqueous extract of the source of caffeine in the herbicidal composition is 50:50 and wherein the dosage rate is 80 to 120 liters of herbicide per hectare.

22. A method of concurrently inhibiting seedling root and shoot growth of unwanted vegetation without affecting growth of crop in a field, the method comprising (a) allowing the crop to germinate in the field, and (b) exposing seeds of the unwanted plants vegetation in the field to an effective amount of the herbicidal composition of claim 1.

23. A method of manufacturing a pre-emergent, non-selective herbicide comprising combining an effective amount of isothiocyanate with an effective amount of caffeine.

24. The method of claim 23, wherein the isothiocyanate is provided within an isothiocyanate aqueous extract solution obtained from a source of the isothiocyanate, and wherein the caffeine is provided within a caffeine aqueous extract solution obtained from a source of caffeine.

25. (canceled)

26. The method of claim 22, wherein the isothiocyanate and the caffeine are synthetic.

27. The method of claim 11, wherein the unwanted vegetation includes T. officinale.

28. The method of claim 22, wherein the unwanted vegetation includes T. officinale.

29. The pre-emergent and non-selective herbicidal composition of claim 1, wherein the isothiocyanate is allyl isothiocyanate.
